(19) United States
(12) Patent Application Publication
(10) Pub. No.: US 2022/0342042 A1
(43) Pub. Date: Oct. 27, 2022

(54) Apparatus for Optically Measuring the Distance to a Target Object

(71) Applicant: Hilti Aktiengesellschaft, Schaan (LI)

(72) Inventors: Torsten GOGOLLA, Schaan (LI); Rafal CIESLAK, Feldkirch (AT); Petra EYRICH, Widnau (CH); Lieu-Kim DANG, Gams (CH)

(21) Appl. No.: 17/761,107

(22) PCT Filed: Sep. 7, 2020
(86) PCT No.: PCT/EP2020/074947

§ 371 Date: Mar. 16, 2022

(30) Foreign Application Priority Data
Sep. 17, 2019 (EP) 19197754.5

(51) Int. Cl. G01S 7/481; G01S 17/08; G02B 27/09; G02B 26/02

(52) U.S. Cl. CPC G01S 7/4812; G01S 17/08; G02B 27/0955; G02B 26/023

(57) ABSTRACT

An apparatus for optically measuring a distance to a target object which is embodied as a scattering target object or a reflecting target object. The apparatus has a distance measuring device and an adjustment device. In the distance measuring device, a laser beam is generated which is adjusted with the aid of the adjustment device to an external optical unit. The adjustment device includes a beam shaping optical unit and a focal shift device.

### BACKGROUND AND SUMMARY OF THE INVENTION

The present invention relates to an apparatus for optically measuring the distance to a target object.

In addition to hand-held measuring devices, known apparatuses for optically measuring distances are provided for installation in total stations, for example. During installation in a total station, the apparatus is combined with further optical elements which are embodied as a telescope, for example. For delimitation purposes, the further optical elements are referred to as an external optical unit.

The prior art has disclosed various propositions to allow an apparatus to be used for optically measuring the distance to scattering target objects and to reflecting target objects. DE 198 40 049 A1 has disclosed an apparatus for optically measuring distances, which generates a first laser beam with a large beam divergence and a second laser beam with a low beam divergence, wherein the first laser beam is provided for optically measuring the distance to scattering target objects and the second laser beam is provided for optically measuring the distance to reflecting target objects. An alternative proposition consists of generating a collimated laser beam in a distance measuring device, it being possible to reshape and adapt the laser beam to the type of target object by means of an adjustment device disposed downstream of the distance measuring device.

EP 2 527 867 B1 has disclosed a distance measuring device with a coaxial arrangement, which generates a collimated laser beam. The distance measuring device comprises a laser beam source, a detector, a beam shaping optical unit with a laser beam shaping optical unit and a reception beam shaping optical unit, and a beam splitting optical unit, which separates the laser beam and reception beam from one another. The beam shaping optical unit is embodied as a collimation optical unit, which reshapes the laser beam into a collimated laser beam. The collimated laser beam which leaves the distance measuring device is designed for optically measuring the distance to scattering target objects. The radiant flux of the laser beam source is too high for the optical distance measurement to reflecting target objects, possibly leading to an overload of the detector. The use of collimated laser beams is disadvantageous in the case of reflecting target objects embodied as individual retroreflectors. A collimated laser beam must be aligned very accurately on the center of the individual retroreflector in order to prevent the case where the reception beam does not impinge upon the detector. If the laser beam does not impinge upon the center of the individual retroreflector, a parallel offset of the reception beam arises in relation to the optical axis of the laser beam.

DE 10 2013 205 589 A1 has disclosed an apparatus for optically measuring the distance to scattering target objects and reflecting target objects. The apparatus comprises a distance measuring device, which comprises a laser beam source, a detector, a beam splitting optical unit, and a beam shaping optical unit with a laser beam shaping optical unit and a reception beam shaping optical unit, and an adjustment device which is disposed in the beam path of the laser beam downstream of the distance measuring device. The adjustment device comprises a second laser beam shaping optical unit and a second reception beam shaping optical unit. The second laser beam shaping optical unit is embodied as a divergent optical unit, which reshapes the collimated laser beam into an expanded laser beam. The second reception beam shaping optical unit is embodied as a diffusion panel, which attenuates the laser beam reflected at the target object. In order to be able to adapt the laser beam to different target objects, the adjustment device can comprise a plurality of second laser beam shaping optical units, which differ from one another in the expanding properties, and/or a plurality of second reception beam shaping optical units, embodied as diffusion panels, which differ from one another in terms of their light scattering properties.

The apparatus for optically measuring distances known from DE 10 2013 205 589 A1 has a plurality of disadvantages: Extraneous light, for example in the form of directly or indirectly incident sunlight, increases the measurement time required for measuring a distance or increases the measurement error in the case of a fixed measurement time. In contrast to the laser beam, extraneous light is not directed but may be incident from different directions. The second reception beam shaping optical units embodied as diffusion panels attenuate extraneous light to a much lesser extent than the directed reception beam. Moreover, the laser beam expanded by means of the divergent optical unit is unsuitable for coupling into an external optical unit.

WO 2016/184735 A1 has disclosed a further apparatus for optically measuring the distance to scattering target objects and reflecting target objects. The apparatus comprises a laser beam source, a detector, and a laser beam shaping device with a first laser beam shaping optical unit and a second laser beam shaping optical unit, which differs from the first laser beam shaping optical unit and which is disposed in the beam path of the laser beam downstream of the first laser beam shaping optical unit.

The first laser beam shaping optical unit is embodied as a collimation optical unit and designed for measuring the distance to scattering target objects. The second laser beam shaping optical unit is embodied as a first array of a plurality of transmission pixels and designed for measuring the distance to reflecting target objects, which may be embodied as individual retroreflectors or surface retroreflectors. By means of a first control unit, the transmittance of the transmission pixels is switchable between three states, non-transmissive with a transmittance of less than 10%, partly transmissive with a transmittance of between 10% and 90%, and fully transmissive with a transmittance of greater than 90%. The laser beam can be adapted to the type of target object by way of the transmittance of the individual transmission pixels of the first array. To prevent an overload of the detector when measuring the distance to reflecting target objects, the radiant flux of the incident reception beam must be significantly lower than the radiant flux of the emitted laser beam.

In the case of an individual retroreflector, at least 50% of the transmission pixels of the first array, which are disposed in the beam path of the laser beam, are switched into the non-transmissive transmission state. The transmission pixels which are disposed in the beam path of the laser beam and have a partly transmissive or fully transmissive embodiment form a transmission aperture for the laser beam, which facilitates a significant expansion of the laser beam. The expansion allows a reduction in the accuracy required in respect of the alignment of the laser beam on the individual retroreflector. In the case of partly transmissive transmission pixels, it is possible to change the proportion of transmitted radiant flux by way of the transmittance of the transmission pixels; the smaller the transmittance, the more pronounced the attenuation of the laser beam becomes.

The apparatus for optically measuring distances known from WO 2016/184735 A1 is disadvantageous in that the transmission aperture masks a large part of the laser beam, which may lead to a significant signal variation in the case of a highly structured and inhomogeneous laser beam. Moreover, the apparatus for optically measuring distances is not suitable for coupling with an external optical unit, such as a zoom lens or a telescope, for example.

The object of the present invention consists in the development of an apparatus for optically measuring distances, which is suitable for optically measuring the distance to scattering target objects and reflecting target objects, wherein the laser beam is coupled into an external optical unit. The apparatus for optically measuring distances should exhibit a stable operation over a temperature range of between −20° C. and +65° C.

According to the invention, the apparatus for optically measuring distances is characterized in that the second laser beam shaping optical unit is embodied as a focusing optical unit, which reshapes the collimated laser beam into a focused laser beam, and the adjustment device comprises a focus displacing device, which is able to be shifted into the beam path of the focused laser beam. The first laser beam shaping optical unit, which is embodied as a collimation optical unit, reshapes the laser beam of the laser beam source into a collimated laser beam which is subsequently reshaped into a focused laser beam by means of the second laser beam shaping optical unit, which is embodied as a focusing optical unit.

A focus displacing device, which is able to be shifted into the beam path of the focused laser beam, is suitable for optically measuring the distance to scattering target objects and to reflecting target objects. Optically measuring the distance to scattering target objects is implemented with a focus displacing device disposed outside of the beam path of the focused laser beam and optically measuring the distance to reflecting target objects, which are embodied as individual retroreflectors, is implemented with a focus displacing device disposed in the beam path of the focused laser beam.

Preferably, the collimation optical unit and the focusing optical unit are fastened to a common optical unit support. A common optical unit support for the collimation optical unit and the focusing optical unit facilitates a fixed position of the focal point in the required temperature range. This ensures a maintenance of the adjusted state for measuring the distance to scattering target objects.

In a preferred variant, the focus displacing device comprises a focus displacing element, wherein the focus displacing device is able to be adjusted between a first state, in which the focus displacing element is disposed outside of the beam path of the laser beam, and a second state, in which the focus displacing element is disposed in the beam path of the laser beam. A focus displacing device which is able to be adjusted between two states is suitable for optically measuring the distance to scattering target objects and to reflecting target objects, which are embodied as individual retroreflectors or as surface retroreflectors. The first state of the focus displacing device, in which the focus displacing element is disposed outside of the beam path of the laser beam, is provided for optically measuring the distance to scattering target objects and the second state of the focus displacing device, in which the focus displacing element is disposed in the beam path of the laser beam, is provided for optically measuring the distance to individual retroreflectors. The first or second state of the focus displacing device can be used to measure the distance to surface retroreflectors.

Preferably, the focus displacing element comprises two slanted plane glass plates, wherein, in the second state of the focus displacing device, a first of the two glass plates is slanted at a positive inclination angle and a second of the two glass plates is slanted at a corresponding negative inclination angle, in each case relative to a propagation plane which is disposed perpendicular to the optical axis of the focused laser beam. By slanting the glass plates relative to the propagation plane perpendicular to the optical axis of the collimated laser beam, it is possible to prevent, or at least reduce, a back-reflection of the laser beam in the direction of the laser beam source or in the direction of the detector. The embodiment of the focus displacing elements made of plane glass plates, which are slanted relative to the propagation plane perpendicular to the optical axis of the focused laser beam, is advantageous in that it is possible to alter the focal position of the focused laser beam. Here, the displacement path can be set by way of the thickness of the glass plates.

In an alternative preferred variant, the focus displacing device comprises a first focus displacing element and a second focus displacing element, wherein the focus displacing device is able to be adjusted between a first state, in which the first and the second focus displacing element are disposed outside of the beam path of the laser beam, a second state, in which the first focus displacing element is disposed in the beam path of the laser beam, and a third state, in which the second focus displacing element is disposed in the beam path of the laser beam. A focus displacing device which is able to be adjusted between three states is suitable for optically measuring the distance to scattering target objects and to reflecting target objects, which are embodied as individual retroreflectors or as surface retroreflectors. The first state of the focus displacing device, in which the first and second focus displacing element are disposed outside of the beam path of the laser beam, is provided for optically measuring the distance to scattering target objects. The second and third state of the focus displacing device, in which the first and second focus displacing element, respectively, are disposed in the beam path of the laser beam, are provided for optically measuring the distance to individual retroreflectors. The first, second or third state of the focus displacing device can be used to measure the distance to surface retroreflectors.

Preferably, the first focus displacing element comprises two slanted first glass plates, wherein, in the second state of the focus displacing device, a first of the two first glass plates is slanted at a positive first inclination angle α₁ and a second of the two first glass plates is slanted at a corresponding negative first −α₁, in each case relative to a propagation plane which is disposed perpendicular to the optical axis of the focused laser beam, and the second focus displacing element comprises two slanted second glass plates, wherein, in the third state of the focus displacing device, a first of the two second glass plates is slanted at a positive second inclination angle α₂ and a second of the two second glass plates is slanted at a corresponding negative second inclination angle −α₂, in each case relative to the propagation plane. By slanting the glass plates relative to the propagation plane perpendicular to the optical axis of the collimated laser beam, it is possible to prevent, or at least reduce, a back-reflection of the laser beam in the direction of the laser beam source or in the direction of the detector. In the case of a focus displacing device with a plurality of focus displacing elements, the focal position of the focused laser beam can be displaced to different extents. Here, the displacement path depends on the thickness of the glass plates that are used for the focus displacing elements.

In a preferred development, the adjustment device comprises an attenuation device, wherein the attenuation device is disposed in the beam path of the laser beam between the first laser beam shaping optical unit and the second laser beam shaping optical unit. Disposing the attenuation device in the beam path of the laser beam between the first and second laser beam shaping optical unit is advantageous in that the attenuation of the laser beam and, where applicable, of the reception beam is implemented in the collimated laser beam. In the beam path of the collimated laser beam, the attenuation element can be slanted in relation to the propagation plane of the collimated laser beam in order to prevent, or at least reduce, a back-reflection of the laser beam in the direction of the laser beam source or of the detector.

In a preferred variant, the attenuation device comprises an attenuation element, wherein the attenuation device is able to be adjusted between a first state, in which the attenuation element is disposed outside of the beam path of the laser beam, and a second state, in which the attenuation element is disposed within the beam path of the laser beam. An attenuation device which is able to be adjusted between two states is suitable for optically measuring the distance to scattering target objects and to reflecting target objects, which are embodied as individual retroreflectors or as surface retroreflectors. The first state of the attenuation device, in which the attenuation element is disposed outside of the beam path of the laser beam, is provided for optically measuring the distance to scattering target objects and the second state of the attenuation device, in which the attenuation element is disposed in the beam path of the laser beam, is provided for optically measuring the distance to reflecting target objects.

Particularly preferably, in the second state of the attenuation device, the attenuation element is slanted at an inclination angle β relative to a propagation plane which is disposed perpendicular to the optical axis of the collimated laser beam. By slanting the attenuation element relative to the propagation plane perpendicular to the optical axis of the collimated laser beam, it is possible to prevent, or at least reduce, a back-reflection of the laser beam in the direction of the laser beam source or in the direction of the detector.

In an alternative preferred variant, the attenuation device comprises a first attenuation element and a second attenuation element, wherein the attenuation device is able to be adjusted between a first state, in which the first and the second attenuation element are disposed outside of the beam path of the laser beam, a second state, in which the first attenuation element is disposed in the beam path of the laser beam, and a third state, in which the second attenuation element is disposed in the beam path of the laser beam. An attenuation device which is able to be adjusted between three states is suitable for optically measuring the distance to scattering target objects and to reflecting target objects, which are embodied as individual retroreflectors or as surface retroreflectors. The first state of the attenuation device, in which the first and second attenuation element are disposed outside of the beam path of the laser beam, is provided for optically measuring the distance to scattering target objects. The second and third state of the attenuation device, in which the first and second attenuation element, respectively, are disposed in the beam path of the laser beam, are provided for optically measuring the distance to reflecting target objects.

Particularly preferably, in the second state of the attenuation device, the first attenuation element is slanted at a first inclination angle β₁ and, in the third state of the attenuation device, the second attenuation element is slanted at a second inclination angle β₂, in each case relative to a propagation plane which is disposed perpendicular to the optical axis of the collimated laser beam. By slanting the first and second attenuation element relative to the propagation plane perpendicular to the optical axis of the collimated laser beam, it is possible to prevent, or at least reduce, a back-reflection of the laser beam in the direction of the laser beam source or in the direction of the detector.

In one development, the apparatus comprises a first reception beam shaping optical unit and the adjustment device comprises a second reception beam shaping optical unit. The first reception beam shaping optical unit is designed for measuring the distance to scattering target objects and the second reception beam shaping optical unit serves to adapt the reception beam to reflecting target objects, which can be embodied as individual retroreflectors or surface retroreflectors.

The present application furthermore relates to a system comprising the apparatus for optically measuring distances and an external optical unit, which is disposed in the beam path of the laser beam downstream of the apparatus. By way of example, the external optical unit is embodied as a zoom lens or telescope.

Preferably, a back side focal plane of the external optical unit substantially coincides with a front side focal plane of the focusing optical unit, wherein no focus displacing element is disposed in the beam path of the laser beam. Should the external optical unit be positioned such that the front side focal plane of the second laser beam shaping optical unit coincides with the back side focal plane of the external optical unit, the focused laser beam is reshaped by the external optical unit into a collimated laser beam, which is used for optically measuring the distance to scattering target objects and to surface retroreflectors. Should the focused laser beam impinge upon a focus displacing element which displaces the front side focal plane of the second laser beam shaping optical unit in relation to the back side focal plane of the external optical unit, the external optical unit cannot collimate the focused laser beam; instead, the focused laser beam is reshaped into an expanded laser beam which is used for optically measuring the distance to individual retroreflectors.

Exemplary embodiments of the invention are described hereinafter with reference to the drawings. It is not necessarily intended for this to illustrate the exemplary embodiments to scale; instead, the drawing, where conducive to elucidation, is produced in schematic and/or slightly distorted form. It should be taken into account here that various modifications and alterations relating to the form and detail of an embodiment may be undertaken without departing from the general concept of the invention. The general concept of the invention is not limited to the exact form or the detail of the preferred embodiment shown and described hereinafter or limited to subject matter that would be limited compared to the subject matter claimed in the claims. For given design ranges, values within the limits mentioned shall also be disclosed as limit values and shall be usable and claimable as desired. For the sake of simplicity, identical reference signs are used hereinafter for identical or similar parts or parts having identical or similar function.

### BRIEF DESCRIPTION OF THE DRAWINGS

FIG. 1 shows a system according to the invention, which comprises an apparatus according to the invention for optically measuring distances and an external optical unit;

FIG. 2 shows the apparatus according to the invention for optically measuring distances of FIG. 1 in a section along the sectional plane in FIG. 1;

FIG. 3 shows the optical distance measurement to a scattering target object by means of an apparatus according to the invention for optically measuring distances;

FIG. 4 shows the optical distance measurement to a reflecting target object, which is embodied as a surface retroreflector, by means of the apparatus illustrated in FIG. 3; and

FIG. 5 shows the optical distance measurement to a reflecting target object, which is embodied as an individual retroreflector, by means of the apparatus illustrated in FIG. 3.

### DETAILED DESCRIPTION OF THE DRAWINGS

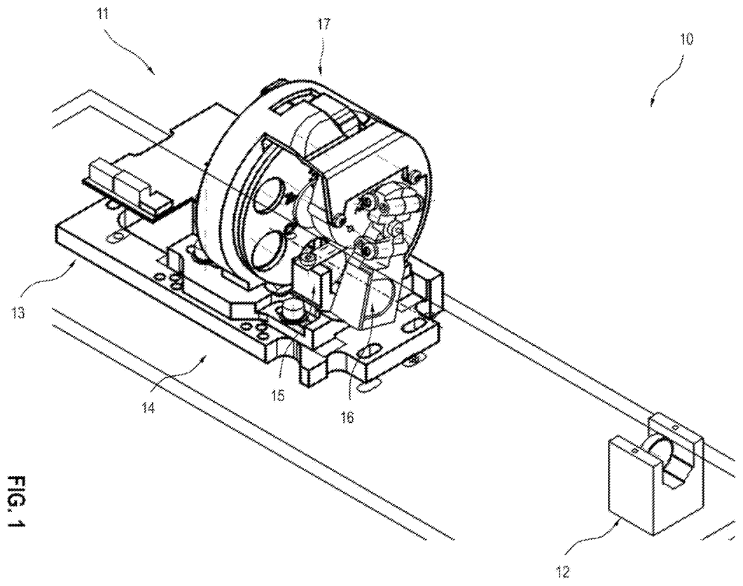

FIG. 1 shows a system 10 according to the invention, which comprises an apparatus 11 according to the invention for optically measuring the distance to a target object and an external optical unit 12. The apparatus 11 comprises a distance measuring device 13 and an adjustment device 14.

A laser beam is generated in the distance measuring device 13, the laser beam being adapted to the external optical unit 12 by means of the adjustment device 14. The adjustment device 14 comprises a beam shaping optical unit 15 and a focus displacing device 16. Additionally, the adjustment device 14 can comprise an attenuation device 17, which is disposed between the distance measuring device 13 and the beam shaping optical unit 15.

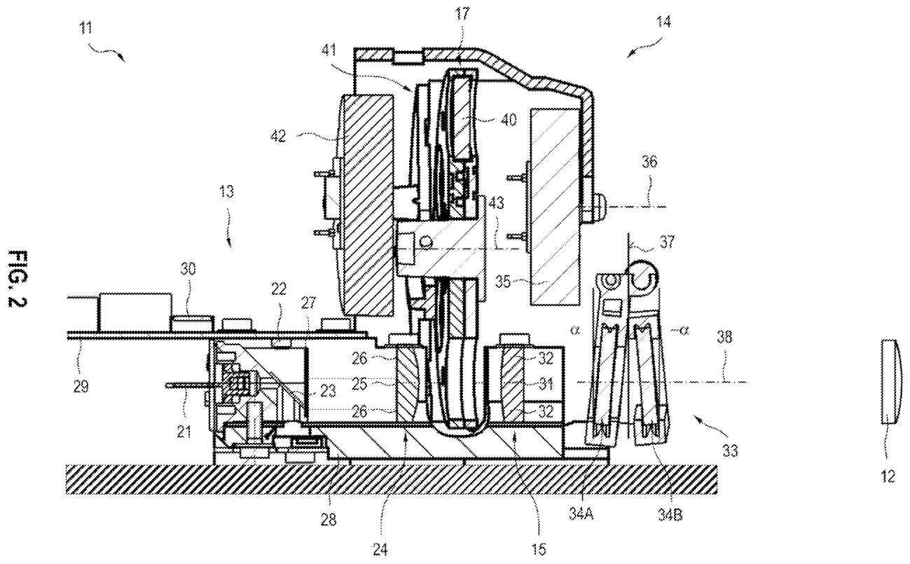

FIG. 2 shows the system 10 according to the invention of FIG. 1 in a section along the sectional plane A-A. The system 10 comprises the distance measuring device 13, the adjustment device 14, and the external optical unit 12.

The distance measuring device 13 comprises a laser beam source 21, which is embodied as a first electro-optical component and which emits a laser beam along an optical axis, and a detector 22, which is embodied as a second electro-optical component and which receives a reception beam that has been scattered or reflected at a target object.

The distance measuring device 13 has a coaxial embodiment, i.e., the laser beam and the reception beam extend coaxially to one another. To separate the laser beam and the reception beam from one another, the distance measuring device 13 comprises a beam splitter optical unit, which can be embodied as a perforated mirror, a polarization beam splitter or a semi-transparent mirror. The distance measuring device 13 comprises a beam splitter optical unit 23, which is embodied as a perforated mirror. In the exemplary embodiment, the reception beam is deflected by the beam splitter optical unit 23 and the laser beam passes through the beam splitter optical unit 23 without deflection.

The laser beam which is emitted by the laser beam source 21 along the optical axis is divergent and must be shaped by means of an optical element. The distance measuring device 13 comprises a first beam shaping optical unit 24, which shapes the laser beam and the reception beam. Since the beam splitter optical unit 23 is embodied as a perforated mirror, the inner region of the first beam shaping optical unit 24 serves for beam shaping of the laser beam and is referred to as first laser beam shaping optical unit 25 and the outer region of the first beam shaping optical unit 24 serves for beam shaping of the reception beam and is referred to as first reception beam shaping optical unit 26. In the case of a beam splitter optical unit embodied as a polarization beam splitter or a semi-transparent mirror, the inner region of the first beam shaping optical unit 24 serves for beam shaping of the laser beam and the entire first beam shaping optical unit 24 serves for beam shaping of the reception beam. An aperture stop 27 can be disposed in the beam path of the laser beam between the beam splitter optical unit 23 and the first beam shaping optical unit 24. The aperture stop 27 serves to prevent, or at least reduce, back-reflections of the laser beam in the direction of the detector 22.

The laser beam source 21, the detector 22, the beam splitter optical unit 23, and the first beam shaping optical unit 24 form the distance measuring device 13. The distance measuring device 13 additionally comprises an optical unit support 28, a circuit board 29, and a control and evaluation device 30. The laser beam source 21, the beam splitter optical unit 23, and the first beam shaping optical unit 24 are fastened to the optical unit support 28 and the detector 22 is fastened to the circuit board 29. The control and evaluation device 30 is connected to the laser beam source 21 and the detector 22 and, for example, determines the distance to a scattering or reflecting target object from a time difference between a reference beam and the reception beam.

The laser beam source 21 emits a divergent laser beam, which is directed at the beam splitter optical unit 23. A greatest possible portion of the laser beam is transmitted to the beam splitter optical unit 23 and the transmitted portion of the laser beam impinges upon the first laser beam shaping optical unit 25, where first beam shaping is implemented. The first laser beam shaping optical unit 25 is embodied as a collimation optical unit, which reshapes the divergent laser beam into a collimated laser beam. The optical properties of the collimation optical unit are adapted for measuring the distance to scattering target objects at a large distance (infinity). In the exemplary embodiment, the first laser beam shaping optical unit 25 and the first reception beam shaping optical unit 26 are embodied as collimation optical units and have the same optical properties. Alternatively, the first laser beam shaping optical unit and the first reception beam shaping optical unit can differ in terms of their optical properties.

The laser beam emerging from the distance measuring device 13 is adapted to the external optical unit 12 by means of the adjustment device 14. The adjustment device 14 comprises the beam shaping optical unit 15, which is referred to as second beam shaping optical unit below, and the focus displacing device 16. The second beam shaping optical unit 15 shapes the laser beam and the reception beam. Since the beam splitter optical unit 23 is embodied as a perforated mirror, the inner region of the second beam shaping optical unit 15 serves for beam shaping of the laser beam and is referred to as second laser beam shaping optical unit 31 and the outer region of the second beam shaping optical unit 15 serves for beam shaping of the reception beam and is referred to as second reception beam shaping optical unit 32. In the case of a beam splitter optical unit embodied as a polarization beam splitter or a semi-transparent mirror, the inner region of the second beam shaping optical unit 15 serves for beam shaping of the laser beam and the entire second beam shaping optical unit 15 serves for beam shaping of the reception beam.

The second laser beam shaping optical unit 31 is embodied as a focusing optical unit, which reshapes the collimated laser beam into a focused laser beam. The optical properties of the focusing optical unit are adapted for measuring the distance to scattering and reflecting target objects. In the exemplary embodiment, the second laser beam shaping optical unit 31 and the second reception beam shaping optical unit 32 are embodied as focusing optical units and have the same optical properties. Alternatively, the second laser beam shaping optical unit and the second reception beam shaping optical unit can differ in terms of their optical properties.

The focus displacing device 16 is disposed between the second laser beam shaping optical unit 15 and the external optical unit 12 and serves to adapt the position of the focal point when measuring the distance to reflecting target objects. The focus displacing device 16 comprises a focus displacing element 33, which comprises two plane glass plates 34A, 34B.

The focus displacing device 16 is able to be adjusted between a first state, in which the focus displacing element 33 is disposed outside of the beam path of the laser beam, and a second state, in which the focus displacing element 33 is disposed within the beam path of the laser beam. In the exemplary embodiment, the focus displacing device 16 is adjusted by way of a stepper motor 35, by means of which the focus displacing element 33 is embodied to be pivotable about a pivot axis 36. FIG. 2 shows the focus displacing device 16 in the second state.

The plane glass plates 34A, 34B are slanted relative to a propagation plane 37 of the laser beam, wherein the propagation plane is disposed perpendicular to the optical axis 38 of the laser beam. The first of the two glass plates 34A is inclined at a positive inclination angle α relative to the propagation plane 37 and the second of the two glass plates 34B is inclined at a corresponding negative inclination angle −α relative to the propagation plane 37, in order to prevent, or at least reduce, a back-reflection of the laser beam in the direction of the laser beam source 21 or in the direction of the detector 22. The inclination angle is measured between the surface of the glass plates 34A, 34B and the propagation plane 37.

The adjustment device 14 can additionally comprise the attenuation device 17, which is disposed between the first laser beam shaping optical unit 25 and the second laser beam shaping optical unit 31. The attenuation device 17 can comprise one attenuation element or a plurality of attenuation elements, which differ from one another in terms of transmittance. Since the beam splitter optical unit 23 is embodied as a perforated mirror, the inner region of an attenuation element serves for attenuating the laser beam and is referred to as laser beam attenuation element and the outer region of an attenuation element serves for attenuating the reception beam and is referred to as reception beam attenuation element. In the case of a beam splitter optical unit embodied as a polarization beam splitter or a semi-transparent mirror, the inner region of an attenuation element serves for attenuating the laser beam and the entire attenuation element serves for attenuating the reception beam.

The attenuation device 17 comprises an attenuation element 40, which is disposed in a rotary wheel 41. The rotary wheel is embodied to be rotatable about an axis of rotation 43 by way of a stepper motor 42. The attenuation device 17 is able to be adjusted between a first state, in which the attenuation element 40 is disposed outside of the beam path of the laser beam, and a second state, in which the attenuation element is disposed within the beam path of the laser beam. FIG. 2 shows the attenuation device 17 in the first state. By means of the attenuation device 17, it is possible to adapt the laser beam to the target object. Within the scope of the present application, a distinction is made between scattering target objects and reflecting target objects.

Target objects at which a laser beam is scattered are defined as scattering target objects, and target objects at which a laser beam is predominantly reflected are defined as reflecting target objects. In the case of reflecting target objects, a distinction is made between individual retroreflectors and surface retroreflectors. Individual retroreflectors are defined to be reflecting target objects which consist of a prism, wherein the dimensions of the prism are greater than the typical laser beam diameters and an incident laser beam captures a surface of the triple prism. Surface retroreflectors are defined to be reflecting target objects which consist of a plurality of prisms disposed next to one another, wherein the dimensions of the prisms are smaller than the typical laser beam diameters and an incident laser beam captures a plurality of prisms; examples of surface retroreflectors are reflection films and cat's eyes.

In the second state of the attenuation device 17, the attenuation element 40 is slanted at an inclination angle β relative to a propagation plane which is disposed perpendicular to the optical axis of the collimated laser beam. By slanting the attenuation element 40 relative to the propagation plane perpendicular to the optical axis of the collimated laser beam, it is possible to prevent, or at least reduce, a back-reflection of the laser beam in the direction of the laser beam source 21 or in the direction of the detector 22.

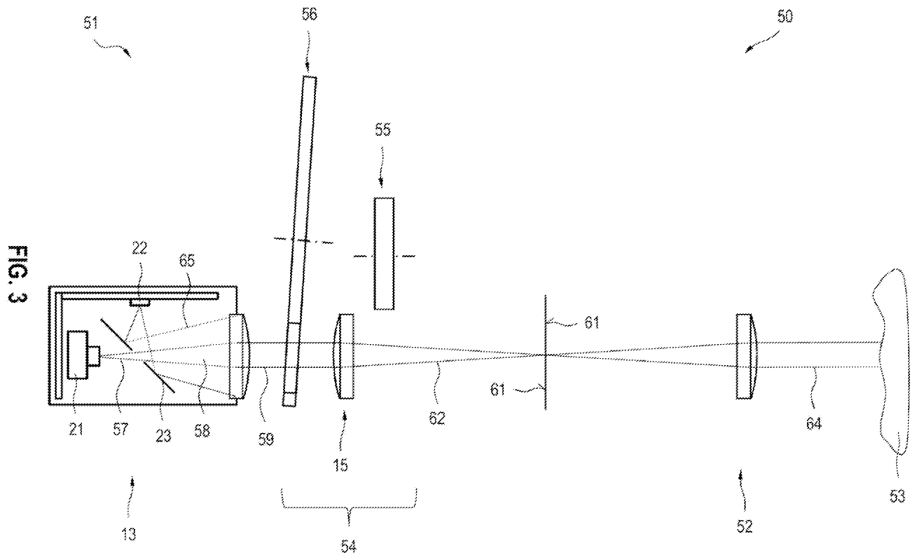

FIG. 3 shows the optical distance measurement to a scattering target object by means of a system 50 according to the invention, which comprises an apparatus 51 according to the invention for optically measuring the distance to a target object and an external optical unit 52. The target object is embodied as a scattering target object 53.

The apparatus 51 comprises the distance measuring device 13 and an adjustment device 54, which differs from the adjustment device 14 of the apparatus 11. The adjustment device 54 comprises the second beam shaping optical unit 15 and a focus displacing device 55. The adjustment device 54 can additionally comprise an attenuation device 56, which is disposed between the first laser beam shaping optical unit 25 and the second laser beam shaping optical unit 31.

The distance measuring device 13 generates a laser beam 57 with an optical axis 58, which passes through the beam splitter optical unit 23 and which is reshaped by the first laser beam shaping optical unit 25 into a collimated laser beam 59. The collimated laser beam 59 has the same dimensions and properties for all target objects. After leaving the distance measuring device 13, the collimated laser beam 59 is reshaped by means of the adjustment device 54 and adapted to the type of target object. In the case of the target objects, a distinction is made between scattering target objects, individual retroreflectors, and surface retroreflectors.

In the case of the optical distance measurement to scattering target objects, the laser beam is scattered over a large angle range at the target object and only a small component of the radiant flux of the scattered laser beam impinges upon the detector 22. The power of the laser beam source 21 is designed such that the radiant flux impinging upon the detector 22 is sufficient for the evaluation, even in the case of scattering target objects. In the case of the optical distance measurement to reflecting target objects, the laser beam is reflected at the target object and impinges upon the detector 22 as a directed reception beam. The radiant flux of the reflected laser beam impinging upon the detector 22 is very much greater than the radiant flux of the scattered laser beam, which can lead to an overload of the detector 22. To prevent an overload of the detector 22, the radiant flux is reduced in the case of reflecting target objects by means of the attenuation device 56.

The attenuation device 56 comprises a first attenuation element and a second attenuation element and is embodied to be adjustable between three different states. The attenuation device 56 is able to be adjusted between a first state, in which the first and the second attenuation element are disposed outside of the beam path of the laser beam, a second state, in which the first attenuation element is disposed within the beam path of the laser beam, and a third state, in which the second attenuation element is disposed within the beam path of the laser beam. What applies in general is that an attenuation device with a number of M different attenuation elements is able to be adjusted between M+1 different states. No attenuation element is situated in the beam path in the first state of the attenuation device, the first attenuation element is situated in the beam path in the second state of the attenuation device, and the M-th attenuation element is situated in the beam path in the M+1-th state of the attenuation device.

In the case of scattering target objects, the beam cross section of the laser beam scattered at the target object should be as small as possible. Therefore, collimated laser beams are used for measuring the distance to scattering target objects. In the case of reflecting target objects embodied as individual retroreflectors, the incident laser beam should impinge upon the center of the individual retroreflector. If the laser beam does not impinge upon the center of the individual retroreflector, the reflected laser beam or reception beam can miss the distance measuring device 13 and hence the detector 22 as a result of the parallel offset. To reduce the demands on the accuracy with which the laser beam must be directed at the center of the individual retroreflector, the laser beam is expanded and a laser beam with a larger beam cross section is directed at the individual retroreflector. For optically measuring the distance to individual retroreflectors, the laser beam is expanded by means of the focus displacing device 55.

The focus displacing device 55 comprises a first focus displacing element and a second focus displacing element and is embodied to be adjustable between three different states. The focus displacing device 55 is able to be adjusted between a first state, in which the first and the second focus displacing element are disposed outside of the beam path of the laser beam, a second state, in which the first focus displacing element is disposed within the beam path of the laser beam, and a third state, in which the second focus displacing element is disposed within the beam path of the laser beam. What applies in general is that a focus displacing device with a number of N different focus displacing elements is able to be adjusted between N+1 different states. No focus displacing element is situated in the beam path in the first state of the focus displacing device, the first focus displacing element is situated in the beam path in the second state of the focus displacing device, and the N-th focus displacing element is situated in the beam path in the N+1-th state of the focus displacing device.

In the case of the optical distance measurement to the scattering target object 53 illustrated in FIG. 3, there is no attenuation of the laser beam, no attenuation of the reception beam, and no expansion of the laser beam. The focus displacing device 55 and the attenuation device 56 are in their first state. The first and second focus displacing element are disposed outside of the beam path of the laser beam in the first state of the focus displacing device 55 and the first and second attenuation element are disposed outside of the beam path of the laser beam in the first state of the attenuation device 56.

The collimated laser beam 59 impinges upon the second laser beam shaping optical unit 31, which is embodied as a focusing optical unit with a front side focal plane 61. The focusing optical unit 15 reshapes the collimated laser beam 59 into a focused laser beam 62. In order to generate a collimated laser beam downstream of the external optical unit 52, the second beam shaping optical unit 15 and the external optical unit 52 must be positioned relative to one another in such a way that the front side focal plane 61 of the second beam shaping optical unit 15 coincides with a back side focal plane 63 of the external optical unit 52. The focused laser beam 62 is reshaped into a collimated laser beam 64 by the external optical unit 52 and directed at the scattering target object 53.

The collimated laser beam 64 is scattered at the scattering target object 53 and impinges upon the detector 22 as a scattered reception beam 65. Along the path from the scattering target object 53 to the detector 22, the scattered reception beam 65 passes the external optical unit 52, the second reception beam shaping optical unit 32, the first reception beam shaping optical unit 26, and the beam splitter optical unit 23.

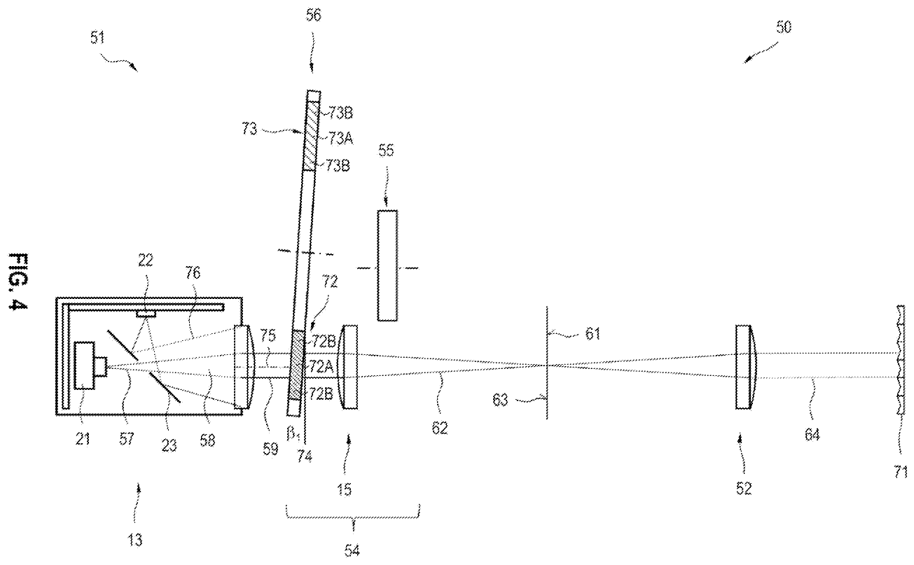

FIG. 4 shows the optical distance measurement by means of the apparatus 51 and the external optical unit 52 to a reflecting target object, which is embodied as a surface retroreflector 71. Here, the structure of FIG. 4 differs from the structure of FIG. 3 in terms of the state of the attenuation device 56.

The attenuation device 56 is in the first state in the case of the optical distance measurement to the scattering target object 53 illustrated in FIG. 3 and the attenuation device 56 is in the second state in the case of the optical distance measurement to the surface retroreflector 71 illustrated in FIG. 4. The focus displacing device 55 is in the first state.

The attenuation device 56 comprises a first attenuation element 72 and a second attenuation element 73, which differ from one another in terms of their attenuation properties, wherein the attenuation properties are set by way of the transmittance. The attenuation device 56 is able to be adjusted between the first state, in which the first and second attenuation element 72, 73 are disposed outside of the beam path of the laser beam, the second state, in which the first attenuation element 72 is disposed within the beam path of the laser beam, and the third state, in which the second attenuation element 73 is disposed within the beam path of the laser beam.

Since the beam splitter optical unit 23 is embodied as a perforated mirror, the inner region 72A of the first attenuation element 72 serves for attenuating the laser beam and is referred to as first laser beam attenuation element 72A and the outer region 72B of the first attenuation element 72 serves for attenuating the reception beam and is referred to as first reception beam attenuation element 72B. The inner region 73A of the second attenuation element 73 serves for attenuating the laser beam and is referred to as second laser beam attenuation element 73A and the outer region 73B of the second attenuation element 73 serves for attenuating the reception beam and is referred to as second reception beam attenuation element 73B. In the case of a beam splitter optical unit embodied as a polarization beam splitter or a semi-transparent mirror, the inner region of an attenuation element serves for attenuating the laser beam and the entire attenuation element serves for attenuating the reception beam.

FIG. 4 shows the attenuation device 56 in the second state, in which the first attenuation element 72 is disposed in the beam path of the collimated laser beam. Disposing the attenuation device 56 in the beam path of the collimated laser beam is advantageous in that the first attenuation element 72 can be slanted in order to prevent, or at least reduce, a back- reflection of the laser beam in the direction of the laser beam source 21 or in the direction of the detector 22. In the second state of the attenuation device 56, the first attenuation element 72 is slanted at a first inclination angle β₁ relative to a propagation plane 74, wherein the propagation plane 74 is disposed perpendicular to the optical axis 75 of the collimated laser beam.

The collimated laser beam 59 is attenuated by means of the first attenuation element 72 and impinges upon the second laser beam shaping optical unit 31, which reshapes the attenuated collimated laser beam 59 into the focused laser beam 62. The external optical unit 52 is positioned such that the front side focal plane 61 of the second laser beam shaping optical unit 31 coincides with the back side focal plane 63 of the external optical unit 52. The focused laser beam 62 is reshaped into the collimated laser beam 64 by the external optical unit 52 and directed at the surface retroreflector 71.

The collimated laser beam 64 is reflected at the surface retroreflector 71 and impinges upon the detector 22 as a reflected reception beam 76. Along the path from the surface retroreflector 71 to the detector 22, the reflected reception beam 76 passes the external optical unit 52, the second reception beam shaping optical unit 32, the first attenuation element 72, the first reception beam shaping optical unit 26, and the beam splitter optical unit 23.

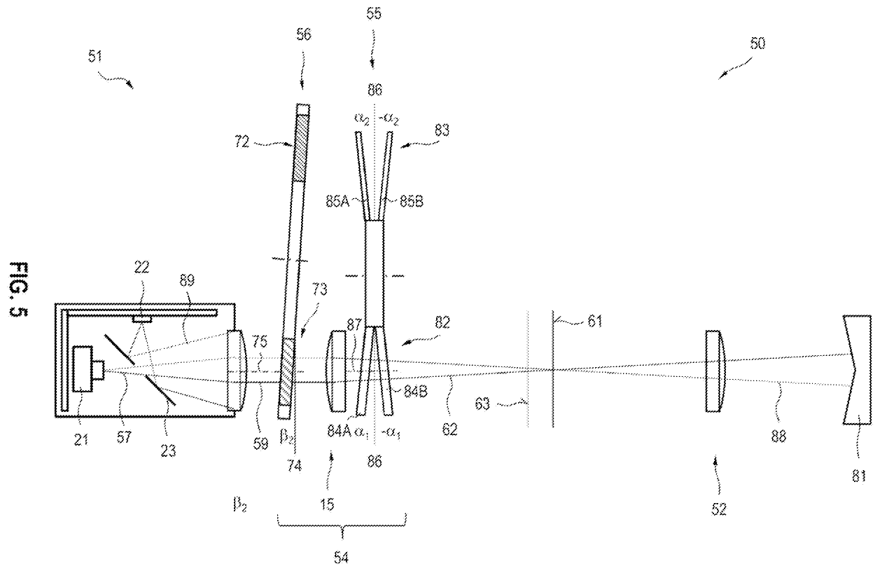

FIG. 5 shows the optical distance measurement by means of the apparatus 51 and the external optical unit 52 to a reflecting target object, which is embodied as an individual retroreflector 81. Here, the structure of FIG. 5 differs from the structure of FIGS. 3 and 4 in terms of the state of the focus displacing device 55 and the state of the attenuation device 56.

The focus displacing device 55 and the attenuation device 56 are in the first state in the case of the optical distance measurement to the scattering target object 53 illustrated in FIG. 3, the focus displacing device 55 is in the first state and the attenuation device 56 is in the second state in the case of the optical distance measurement to the surface retroreflector 71 illustrated in FIG. 4, and the focus displacing device 55 is in the second state and the attenuation device 56 is in the third state in the case of the optical distance measurement to the individual retroreflector 81 illustrated in FIG. 5.

FIG. 5 shows the attenuation device 56 in the third state, in which the second attenuation element 73 is disposed in the beam path of the laser beam. By disposing the attenuation device 56 in the beam path of the collimated laser beam, it is possible to slant the second attenuation element 73 in order to prevent, or at least reduce, a back-reflection of the laser beam in the direction of the laser beam source 21 or in the direction of the detector 22. In the third state of the attenuation device 56, the second attenuation element 73 is slanted at a second inclination angle β₂ relative to the propagation plane 74 which is disposed perpendicular to the optical axis 75 of the collimated laser beam. The second inclination angle β₂ of the second attenuation element 73 and the first inclination angle β₁ of the first attenuation element 72 preferably correspond, although they can also differ from one another.

The focus displacing device 55 comprises a first focus displacing element 82 and a second focus displacing element 83, which differ from one another in terms of their optical properties. The focus displacing device 55 is able to be adjusted between the first state, in which the first and second focus displacing element 82, 83 are disposed outside of the beam path of the laser beam, the second state, in which the first focus displacing element 82 is disposed within the beam path of the laser beam, and the third state, in which the second focus displacing element 83 is disposed within the beam path of the laser beam.

The first focus displacing element 82 comprises two slanted first glass plates 84A, 84B and the second focus displacing element 83 comprises two slanted second glass plates 85A, 85B. The first glass plates 84A, 84B and second glass plates 85A, 85B are slanted relative to a propagation plane 86 which is disposed perpendicular to the optical axis 87 of the focused laser beam 62. The first of the two first glass plates 84A is slanted at a positive first inclination angle α₁ and the second of the two first glass plates 84B is slanted at a corresponding negative first inclination angle −α₁, in each case relative to the propagation plane 86. The first of the two second glass plates 85A is slanted at a positive second inclination angle α₂ and the second of the two second glass plates 85B is slanted at a corresponding negative second inclination angle −α₂, in each case relative to the propagation plane 86. As a result of the inclination of the glass plates, a back-reflection of the laser beam in the direction of the laser beam source 21 or in the direction of the detector 22 is prevented or at least reduced.

The collimated laser beam 59 impinges upon the second attenuation element 73, at which the collimated laser beam is attenuated. The collimated laser beam 59 impinges upon the second laser beam shaping optical unit 31, which reshapes the collimated laser beam 59 into the focused laser beam 62. The focused laser beam 62 impinges upon the first focus displacing element 82, which displaces the front side focal plane 61 of the second laser beam shaping optical unit 31 in relation to the back side focal plane 63 of the external optical unit 52. As a result of the displacement, the external optical unit 52 does not collimate the focused laser beam 62 but expands it instead. The focused laser beam 62 is reshaped into an expanded laser beam 88 by the external optical unit 52.

The expanded laser beam 88 is reflected at the individual retroreflector 81 and impinges upon the detector 22 as a reflected reception beam 89. Along the path from the individual retroreflector 81 to the detector 22, the reflected reception beam 89 passes the external optical unit 52, the first focus displacing element 82, the second reception beam shaping optical unit 32, the second attenuation element 73, the first reception beam shaping optical unit 26, and the beam splitter optical unit 23.

1.-14. (canceled)

15. An apparatus (11; 51) for optically measuring a distance to a target object (53; 71; 81), which is embodied as a scattering target object (53) or a reflecting target object (71; 81), comprising:
a laser beam source (21) which is embodied as a first electro-optical component and which emits a laser beam (57) along an optical axis (58);
a detector (22) which is embodied as a second electro-optical component and which receives a reception beam (65) that has been scattered at the target object or a reception beam (76; 89) that has been reflected at the target object;
a first laser beam shaping optical unit (25) which is embodied as a collimation optical unit and which reshapes the laser beam (57) into a collimated laser beam (59);
an adjustment device (14; 54) with a second laser beam shaping optical unit (31) which is disposed in a beam path of the laser beam downstream of the first laser beam shaping optical unit (25); and
a beam splitting optical unit (23) which separates the laser beam and the reception beam from one another and which is disposed in the beam path of the laser beam upstream of the first laser beam shaping optical unit (25);
wherein the second laser beam shaping optical unit (31) is embodied as a focusing optical unit which reshapes the collimated laser beam (59) into a focused laser beam (62) and wherein the adjustment device (14; 54) comprises a focus displacing device (16; 55) which is shiftable into a beam path of the focused laser beam (62).

16. The apparatus as claimed in claim 15, wherein the first laser beam shaping optical unit (25) and the second laser beam shaping optical unit (31) are fastened to a common optical unit support (28).

17. The apparatus as claimed in claim 15, wherein the focus displacing device (16) comprises a focus displacing element (33) and wherein the focus displacing device (16) is adjustable between a first state in which the focus displacing element (33) is disposed outside of the beam path of the laser beam and a second state in which the focus displacing element (33) is disposed in the beam path of the laser beam.

18. The apparatus as claimed in claim 17, wherein the focus displacing element (33) comprises two slanted plane glass plates (34A, 34B) and wherein in the second state of the focus displacing device (16) a first one of the two glass plates (34A) is slanted at a positive inclination angle (α) and a second one of the two glass plates (34B) is slanted at a corresponding negative inclination angle (−α), in each case relative to a propagation plane (37) which is disposed perpendicular to the optical axis (38) of the laser beam.

19. The apparatus as claimed in claim 15, wherein the focus displacing device (55) comprises a first focus displacing element (82) and a second focus displacing element (83) and wherein the focus displacing device (55) is adjustable between a first state in which the first and the second focus displacing element (82, 83) are disposed outside of the beam path of the laser beam, a second state in which the first focus displacing element (82) is disposed in the beam path of the laser beam, and a third state in which the second focus displacing element (83) is disposed in the beam path of the laser beam.

20. The apparatus as claimed in claim 19, wherein the first focus displacing element (82) comprises two slanted first glass plates (84A, 84B), wherein in the second state of the focus displacing device (55) a first one of the two first glass plates (84A) is slanted at a positive first inclination angle (α₁) and a second one of the two first glass plates (84B) is slanted at a corresponding negative first inclination angle (−α₁), in each case relative to a propagation plane (86) which is disposed perpendicular to the optical axis (87) of the laser beam, wherein the second focus displacing element (83) comprises two slanted second glass plates (85A, 85B), and wherein in the third state of the focus displacing device (55) a first one of the two second glass plates (85A) is slanted at a positive second inclination angle (α₂) and a second one of the two second glass plates (85B) is slanted at a corresponding negative second inclination angle (−α₂), in each case relative to the propagation plane (86).

21. The apparatus as claimed in claim 15, wherein the adjustment device (14; 54) comprises an attenuation device (17; 56) and wherein the attenuation device (17; 56) is disposed in the beam path of the laser beam between the first laser beam shaping optical unit (25) and the second laser beam shaping optical unit (31).

22. The apparatus as claimed in claim 21, wherein the attenuation device (17) comprises an attenuation element (40) and wherein the attenuation device (17) is adjustable between a first state in which the attenuation element (40) is disposed outside of the beam path of the laser beam and a second state in which the attenuation element (40) is disposed in the beam path of the laser beam.

23. The apparatus as claimed in claim 22, wherein, in the second state of the attenuation device (17), the attenuation element (40) is slanted at an inclination angle (β) relative to a propagation plane (37) which is disposed perpendicular to the optical axis (38) of the collimated laser beam (59).

24. The apparatus as claimed in claim 21, wherein the attenuation device (56) comprises a first attenuation element (72) and a second attenuation element (73) and wherein the attenuation device (56) is adjustable between a first state in which the first and the second attenuation element (72, 73) are disposed outside of the beam path of the laser beam, a second state in which the first attenuation element (72) is disposed in the beam path of the laser beam, and a third state in which the second attenuation element (73) is disposed in the beam path of the laser beam.

25. The apparatus as claimed in claim 24, wherein, in the second state of the attenuation device (56), the first attenuation element (72) is slanted at a first inclination angle (β₁) and, in the third state of the attenuation device (56), the second attenuation element (73) is slanted at a second inclination angle (β₂), in each case relative to a propagation plane (74) which is disposed perpendicular to the optical axis (75) of the collimated laser beam.

26. The apparatus as claimed in claim 15, further comprising a first reception beam shaping optical unit (26) and a second reception beam shaping optical unit (32).

27. A system (10; 50), comprising:
the apparatus (11; 51) for optically measuring a distance as claimed in claim 15; and
an external optical unit (12; 52) which is disposed in the beam path of the laser beam downstream of the apparatus (11; 51).

28. The system as claimed in claim 27, wherein a back side focal plane (63) of the external optical unit (52) coincides with a front side focal plane (61) of the second laser beam shaping optical unit (31), wherein no focus displacing element is disposed in the beam path of the laser beam.
